(19) United States
(12) Patent Application Publication
(10) Pub. No.: US 2025/0137510 A1
(43) Pub. Date: May 1, 2025

(54) PILOT VALVE SEAT AND ELECTROMAGNETIC VALVE

(71) Applicant: BorgWarner Automotive Components (Tianjin) Co., Ltd., Tianjin (CN)

(72) Inventors: Yuan Zhengzheng, Tianjin (CN); Li Jian, Tianjin (CN); Zhou Jin, Tianjin (CN); Shen Zhouzhou, Tianjin (CN); Yao Yanqing, Tianjin (CN); Zhao Li, Tianjin (CN); Liu Xianfeng, Tianjin (CN)

(21) Appl. No.: 18/988,074

(22) Filed: Dec. 19, 2024

(30) Foreign Application Priority Data
Oct. 23, 2023 (CN) 202311372665.0

(51) Int. Cl. F16F 9/34

(52) U.S. Cl. CPC F16F 9/34

(57) ABSTRACT

A pilot valve seat for use in a damping valve in a shock absorber, comprising a pilot valve spool, a pilot valve seat, and a pilot spring disposed between the pilot valve spool and the pilot valve seat; the pilot valve spool and the pilot valve seat are connected with the housing; the pilot valve seat is provided with an oil inlet chamber for guiding the oil in the main valve chamber of the damping valve to the pilot chamber; the oil inlet chamber includes a radial oil inlet hole for oil inlet and a radial oil outlet hole for oil outlet; the pilot valve spool is provided with an adjusting cylinder matched with the oil inlet chamber, and the adjusting cylinder can move axially to control the flow rate of the oil inlet chamber and realize the pressure control in the pilot chamber.

### CROSS REFERENCE TO RELATED APPLICATIONS

This application claims the priority to Chinese Patent Application No. CN202311372665.0 filed on Oct. 23, 2023, and the entire content of this priority application is incorporated herein by reference in its entirety.

### TECHNICAL FIELD

The application relates to technology of the vehicle vibration damping devices, that is a pilot valve and a damping valve.

### BACKGROUND

Shock absorbers are an important component of vehicle suspension systems, designed to suppress oscillations caused by the rebound of shock-absorbing springs and impacts from the road. It acts to dampen vibrations between a chassis and a vehicle body, improving the smoothness of the vehicle's ride and its handling stability. The shock absorber comprises a damping valve, which controls the flow of hydraulic fluid within a chamber of the shock absorber, facilitating the adjustment of damping properties of the shock absorber to provide effective shock absorption for the vehicle. In the prior art, the damping valve regulates the pressure in a pilot valve chamber by adjusting the input current, thereby controlling the opening of a main spool to adjust the damping level of the shock absorber.

In the prior art, Chinese patent reference number CN219317506U, provides a damper damping adjustable damping valve. The bottom of the installation chamber is also provided with a pilot valve for connecting the valve chamber with the oil outlet gap. The pilot valve includes an upper valve seat, a lower valve seat and a valve ball. The upper valve seat is also provided with an oil outlet hole, and the lower valve seat is provided with a pilot spring, so that the valve ball always has a tendency to move upward to seal the upper valve seat; the upper end of the housing is provided with an pushrod and an electromagnetic driving assembly for driving the pushrod to move up and down, and when the electromagnetic driving assembly is powered, the pushrod can move downward to make the valve ball move downward after overcoming the elastic force and hydraulic force of the pilot spring; during compression, a small part of the oil in the oil inlet passage enters the pilot valve from the first check valve and then flows into the oil outlet passage through the fourth check valve. Under the action of the pilot valve, the main spool is opened, and most of the oil enters the oil outlet passage from the gap between the main spool and the installation chamber; during recovery, a small part of the oil in the oil outlet channel enters the pilot valve from the second check valve and then flows back to the liquid inlet channel through the third check valve. Under the action of the pilot valve, the main spool is opened, and most of the oil flows back to the oil outlet channel from the gap between the main spool and the installation chamber.

According to the above technical solution, on the one hand, the pilot valve in the prior art has a complex structure, and when the pressure of the pilot chamber is controlled by the up and down movement of the valve ball, the pushrod acts on the valve ball to push the valve ball to move up and down, but the surface of the valve ball is a curved surface, and the valve ball can roll in the pilot chamber, so the contact point between the valve ball, the pushrod and the spring is not unique, which makes the whole system not stable enough.

On the other hand, the pilot valve hole is arranged along the vertical direction and faces the pilot spring. When the oil in the main valve chamber enters the pilot chamber, the pressure of the oil acts on the pilot spring, so it may cause unnecessary force to the pilot spring and act on the valve ball to cause the sway of the valve ball. Moreover, the oil flows out into the oil outlet gap through the throttling gap between the valve ball and the pilot valve spool. When the valve ball becomes unstable, such as shaking and deviating, it will affect the size of the throttling gap between the valve ball and the pilot valve spool and the stability of the valve ball and its sealing effect on the pilot chamber, further affecting the pressure regulation effect on the pilot chamber, the oil outlet effect of the pilot valve and the damping regulation effect of the shock absorber.

It can be seen that the damping valve for shock absorbers of the above technical solution has many unstable factors, which may lead to unstable oil output, resulting in high instability of pressure control in the pilot chamber, and then unstable control of the damping of the damping valve; accordingly, prior art adjustable damping valves of shock absorber damping have room for further improvement.

### SUMMARY

In view of the above technical problems, firstly, we provide a pilot valve seat, which has a stable oil discharge structure of a pilot chamber and a good pressure control effect on the pilot chamber; secondly, we provide a damping valve including the pilot valve seat, the effect is relatively good.

The present application provides a pilot valve seat is applicable to a damping valve in a shock absorber, the damping valve comprises a pilot valve assembly, a valve sleeve and a housing. The housing is connected with the valve sleeve, and the pilot valve assembly is arranged in the valve sleeve; the pilot valve assembly includes a pilot valve spool, a pilot seat, and a pilot spring;

The pilot spring is installed between the pilot valve spool and the pilot valve seat;

The pilot chamber comprises the pilot valve spool, the pilot valve seat, the housing and the valve sleeve of the damping valve;

The pilot valve seat is provided with an oil inlet chamber, and the oil inlet chamber is connected to the pilot chamber;

The oil inlet chamber comprises a radial inlet hole and an oil outlet hole;

The pilot valve spool is provided with an adjusting cylinder matched with the oil inlet chamber, and the adjusting cylinder can move axially with the pilot valve spool to control the flow rate of the oil inlet chamber.

Compared with the prior art, the pilot valve of the present application controls the adjusting cylinder to move axially in the oil inlet chamber to change the volume of the adjusting cylinder in the oil inlet chamber to change the space in which the oil body can flow in the oil inlet chamber, thereby adjusting the flow rate of the oil inlet chamber and then adjusting the pressure in the pilot chamber.

The adjusting cylinder is arranged on the pilot valve spool, that is, the above adjustment can be realized only by moving the pilot valve spool. Compared with the adjusting valve ball in the prior art to realize the pressure adjustment of the pilot chamber, the adjustment process of the present application has fewer uncertain factors, realizing more stable process, simple and stable structure, and better effect.

Furthermore, in the present application, the radial oil inlet hole is provided, which makes the oil in the main valve chamber flow into the oil inlet chamber from the radial direction, avoids the oil in the main valve chamber from directly axially opposing the adjusting cylinder, and reduces the shake of adjusting cylinder caused by the oil pressure.

In some optional embodiments, the top of the oil inlet chamber is provided with an axial mounting hole that is mated with the adjusting cylinder. The adjusting cylinder enters the oil inlet chamber through the mating hole to adjust the flow rate of the oil inlet chamber.

In some optional embodiments, the oil inlet chamber comprises an upper chamber and a lower chamber connecting to each other; the upper chamber protrudes upward into the pilot chamber, and the radial oil outlet hole is arranged on the upper chamber; the lower chamber protrudes downward into the main valve chamber, and the radial oil inlet hole is arranged on the lower chamber.

In some optional embodiments, the lower chamber includes an axial connecting port for connecting to the upper chamber; the adjusting cylinder includes a first portion that is accessible into the lower chamber through the axial connecting port.

In some optional embodiments, the adjusting cylinder comprises a second portion that mates with the axial mounting hole; an outer diameter of the second portion is larger than a diameter of the axial connecting port.

In some optional embodiments, the inner diameter of the upper chamber is larger than the outer diameter of the second portion.

In some optional embodiments, the axial length of the adjusting cylinder is less than that of the oil inlet chamber.

An axial length of the second portion is less than that of the upper chamber.

In some optional embodiments, the pilot valve spool comprises a supporting seat, and the adjusting cylinder is connected at a lower end of the supporting seat; one end of the supporting seat close to the adjusting cylinder is provided with a limiting protrusion.

The pilot valve of the present application has at least the following technical effects:
1. By setting up the cooperation between the oil inlet chamber and the adjusting cylinder to regulate the pressure in the pilot chamber, there are fewer uncertain factors and relatively stable structure when the adjusting cylinder moves with the pilot valve spool;
2. The setting of the radial oil inlet hole and the radial oil outlet hole can prevent the hydraulic pressure of the oil from affecting the adjusting cylinder in the axial direction, thereby reducing the influence of the adjusting cylinder by forces in other directions, which is conducive to improving the stability of the adjusting cylinder;
3. The axial matching hole has a guiding and limiting effect on the axial movement of the adjusting cylinder to ensure that the axial movement of the adjusting cylinder in the oil inlet chamber is more stable and smooth, thereby further ensuring that the pressure control of the pilot chamber is more stable and effective;
4. By setting the upper convex chamber and the lower convex chamber, the contact depth between the oil inlet chamber and the main valve chamber can be prolonged when oil enters, and the oil can enter into the oil chamber more easily, and the contact depth with the pilot chamber can be prolonged when oil is exited from the oil inlet chamber, so that the oil in the oil inlet chamber can enter the pilot chamber more effectively.

Secondly, the present application provides a damping valve for use in a vehicle vibration damping device, including a pilot valve as described in any one of the above embodiments.

The damping valve comprises a main spool, a main valve seat and a motor assembly. The main spool and the main valve seat are arranged in the valve sleeve, and the main valve seat is arranged at the bottom of the main spool.

A pilot chamber for installing a pilot valve is arranged in the valve sleeve.

A fixed channel and an adjustable channel for discharging oil in the pilot chamber are formed between the pilot chamber, the valve sleeve and the housing.

The motor assembly can drive the pilot valve spool to move axially relative to the pilot valve seat to change the open area of the adjustable passage, thereby realizing the adjustment of the opening degree between the main spool and the main valve seat.

In some optional embodiments, the pilot valve spool is provided with an oil outlet hole, and the oil in the pilot chamber can flow into the adjustable channel through the oil outlet hole.

The damping valve of the present application has at least the following technical effects:

By driving the pilot valve spool to move up and down in the axial direction of the motor assembly to change the size of the adjustable channel, and arranging the adjustable channel between the pilot valve spool and the housing, the adjustable channel is less affected by uncertain factors, resulting in more stable structure and relatively stable regulation of pressure in the pilot chamber. The response to the opening degree control of the main valve chamber is fast and stable with good effect.

### BRIEF DESCRIPTION OF THE DRAWINGS

FIG. 1 is a three-dimensional structural diagram of a pilot valve assembly.

FIG. 2 is a three-dimensional structural explosion diagram of a pilot valve assembly.

FIG. 3 is a three-dimensional structural explosion diagram of a pilot valve.

FIG. 4 is an axial cross-sectional schematic diagram of a pilot valve.

FIG. 5 is a schematic structural diagram of a damping valve.

FIG. 6 is a schematic axial cross-sectional diagram of a damping valve.

FIG. 7 is an enlarged schematic view of part A of FIG. 6.

FIG. 8 is an enlarged schematic view of a portion B of FIG. 7.

### DETAILED DESCRIPTION

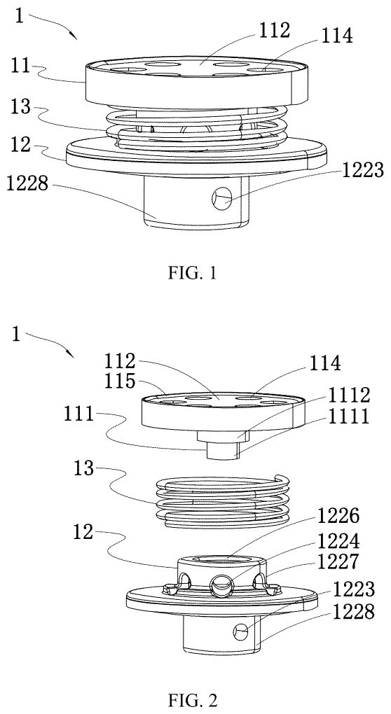

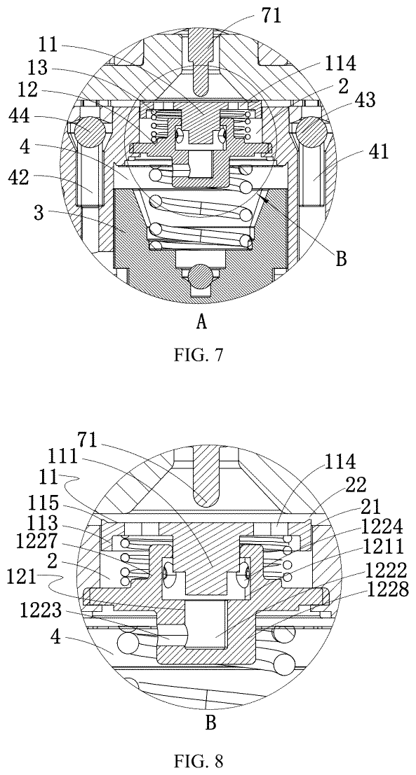

The present application shall be described in more detail with reference to diagrams. See FIGS. 1 to 8.

Firstly, the present application provides a pilot valve seat for use in a damping valve in a shock absorber. The damping valve comprises a pilot valve assembly 1, a main spool 3, a valve sleeve 5 and a housing 6. The housing 6 is connected with the valve sleeve 5, the main spool 3 and the pilot valve assembly 1 are arranged in the valve sleeve 5; the pilot valve assembly 1, the housing 6 and the valve sleeve 5 form a pilot chamber 2. The pilot valve assembly 1 of the damping valve controls the opening degree of the main spool 3 in the damping valve by changing the pressure in the pilot chamber 2, so as to realize the adjustment of the damping magnitude of the shock absorber by the damping valve.

As shown in FIGS. 1 to 4, the pilot valve assembly 1 includes a pilot valve spool 111, a pilot valve seat 12, and a pilot spring 13 disposed between the pilot valve spool 111 and the pilot valve seat 12; the upper end of the pilot spring 13 is in contact with the lower end of the pilot valve spool 111, and the lower end of the pilot spring 13 is in contact with the upper end of the pilot valve seat 12; when the upper end surface of the pilot valve spool 111 receives the downward biasing force of the pushrod 71, the pilot valve spool 111 moves downward to squeeze and compress the pilot spring 13, the pilot spring 13 generates a reaction force, and when the biasing force exerted by the pushrod 71 on the pilot valve spool 111 disappears, the pilot valve spool 111 moves upward and resets under the action of the pilot spring 13, the pilot valve spool 111 can move up and down in the axial direction relative to the pilot valve seat 12; and the pilot spring 13 has the functions of absorbing vibration and buffering, the pushrod 71 can be relatively stable when pushing the pilot valve spool 111 downward.

As shown in FIGS. 2 to 8, the pilot valve seat 12 is provided with an oil inlet chamber 121, and the oil inlet chamber 121 is used for guiding the oil in the main valve chamber 4 of the damping valve into the pilot chamber 2, that is, the oil inlet chamber 121 communicates the pilot chamber 2 with the main valve chamber 4, and the oil liquid in the main valve chamber 4 can enter the pilot chamber 2 through the oil inlet chamber 121.

As shown in FIGS. 1 to 4, the oil inlet chamber 121 includes a radial oil inlet hole 1223 for oil inlet, and a radial oil outlet hole 1224 for oil outlet; the pilot valve spool 111 is provided with an adjusting cylinder 111 matched with the oil inlet chamber 121, and the adjusting cylinder 111 can move axially with the pilot valve spool 111 to control the flow rate of the oil inlet chamber 121, thereby realizing the pressure control in the pilot chamber 2; in this embodiment, the adjusting cylinder 111 can enter the oil inlet chamber 121 through the axial mounting hole 1225. With the axial movement of the adjusting cylinder 111 in the oil inlet chamber 121, the volume size of the adjusting cylinder 111 in the oil inlet chamber 121 can be changed to change the space in the oil inlet chamber 121 through which the oil liquid can flow, thereby controlling the flow rate of the oil inlet chamber 121 to realize the pressure adjustment of the pilot chamber 2; the adjusting cylinder 111 is arranged on the pilot valve spool 111, that is, the above-mentioned adjustment can be realized only by moving the pilot valve spool 111. Compared with the adjusting valve ball in the prior art to realize the pressure adjustment of the pilot chamber 2, the adjustment process of the present application is less uncertain, the adjustment process is more stable, the structure is simple and stable, and the adjustment effect is better.

Further, the adjusting cylinder 111 may be a cylindrical shape, a square column shape, a tapered column or other shape, and the specific shape shall not be limited in the present application.

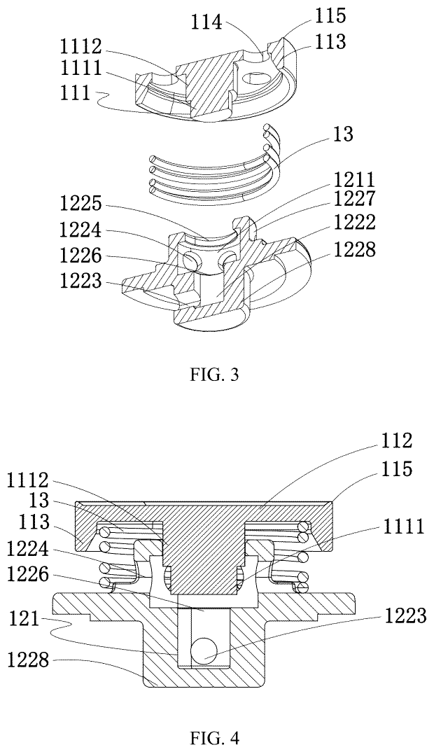

Further, as shown in FIGS. 2 to 3, the top of the oil inlet chamber 121 is provided with an axial mounting hole 1225 that is gap fitted with the adjusting cylinder 111, and the adjusting cylinder 111 enters the oil inlet chamber 121 through the fitting hole to adjust the flow rate of the oil inlet chamber 121. In this embodiment, the axial mounting hole 1225 has a guiding and limiting effect on the axial movement of the adjusting cylinder 111, so as to ensure that the axial movement of the adjusting cylinder 111 in the oil inlet chamber 121 is more stable and smooth, thereby further ensuring that the pressure regulation of the pilot chamber 2 is more stable and the effect is better; the bore diameter of the axial mounting hole is slightly larger than that of the adjusting cylinder 111, so that the adjusting cylinder 111 can smoothly move axially relative to the axial mounting hole 1225.

In another optional embodiment of the present application, the oil inlet chamber 121 is further improved; as shown in FIGS. 2 to 4, the oil inlet chamber 121 includes an upper chamber 1211 and a lower chamber 1222 connecting to each other, and the upper chamber 1211 and the lower chamber 1222 are substantially cylindrical spaces as a whole; in the present embodiment, the pilot valve seat 12 includes a first protrusion 1227 located on a side of the pilot valve seat 12 proximal to the pilot valve spool 11, a second protrusion 1228 located on a side of the pilot valve seat 12 remote from the pilot valve spool 11, an upper chamber 1211 located on the first protrusion 1227, and a lower chamber 1222 located on the second protrusion 1228; the second protrusion 1228 is axially convex to increase the volume of the oil inlet chamber 121 without increasing the volume of the rest of the pilot valve seat 12, in addition to increasing the extension depth of the lower chamber 1222, so that the fluid in the lower end of the pilot valve seat 12 can smoothly enter the oil inlet chamber 121, and the second protrusion 1228 is axially convex to increase the upward extension height of the upper chamber 1211, so that the fluid in the oil inlet chamber 121 can flow to the upper end of the pilot valve seat 12 more smoothly.

The upper chamber 1211 projects upwardly into the pilot chamber 2, and the radial oil outlet hole 1224 is provided on the upper chamber 1211 that communicates with the pilot chamber 2; the lower chamber 1222 projects downward into the main valve chamber 4, and a radial oil inlet hole 1223 is provided on the lower chamber 1222, and the lower chamber 1222 communicates with the main valve chamber 4. In this embodiment, the upper chamber 1211 protrudes upward into the pilot chamber 2, the lower chamber 1222 protrudes downward into the main valve chamber 4, and the volume of the oil inlet chamber 121 can be increased without increasing the volume of the rest of the pilot valve seat 12. In addition, the contact depth between the lower chamber 1222 and the main valve chamber 4 can be increased, so that the oil in the main valve chamber 4 can smoothly enter the oil inlet chamber 121, and the upper chamber 1211 protrudes upward into the pilot chamber 2.

Further, as shown in FIGS. 2 and 3, the lower chamber 1222 includes an axial connecting port 1226 for connecting with the upper chamber 1211; The adjusting cylinder 111 includes a first portion 1111, and the first portion 1111 can enter the lower chamber 1222 through the axial connecting port 1226, so that the adjusting cylinder 111 can act in the lower chamber 1222 and change the space in which the oil can flow in the lower chamber 1222, so as to adjust the amount and speed of the oil flowing into the upper chamber 1211 in the lower chamber 1222, adjust the flow rate and the oil discharge rate of the oil inlet chamber 121, and make the pressure control effect of the pilot valve assembly 1 better and more sensitive. In the present embodiment, the outer diameter of the first portion 1111 is slightly smaller than the inner diameter of the axial connecting port 1226, so that the first portion 1111 of the adjusting cylinder 111 can smoothly enter and exit the axial connecting port 1226.

Further, the first portion 1111 may be a cylindrical shape, a square shape, a tapered shape or other shape. The end portion of the first portion 1111 may be provided as a flat surface or a tapered structure, and the shape of the first portion 1111 is not limited in the present application.

Further, as shown in FIGS. 2 and 4, the adjusting cylinder 111, the upper chamber 1211, and the lower chamber 1222 are basically cylindrical, their central axes are on the same straight line in the vertical direction, the inner diameter of the axial connecting port 1226 is equal to the radial inner diameter of the lower chamber 1222, and the axial connecting port 1226 is circular.

Further, as shown in FIGS. 1 to 4, the adjusting cylinder 111 includes a second portion 1112 connected above the first portion 1111, and the entire second portion 1112 is basically cylindrical; the second portion 1112 is engaged with an axial mounting hole 1225, and the inner diameter of the axial mounting hole 1225 is slightly larger than that of the second portion 1112, so that the second portion 1112 can smoothly move axially relative to the axial mounting portion; the outer diameter of the second portion 1112 is larger than the diameter of the axial connecting port 1226, so that the second portion 1112 does not enter the lower chamber 1222, and the outer diameter of the second portion 1112 is increased, which can improve the structural strength of the second portion 1112, and is beneficial to adjust the structural stability and connection stability of the column 111.

In addition, by increasing the outer diameter of the second portion 1112, when the first portion 1111 moves downward, the second portion 1112 also enters the upper chamber 1211 and occupies the space in the upper chamber 1211, and the volume of the second portion 1112 is larger than that of the first portion 1111, so that after the first portion 1111 moves downward, the space in which the oil supply liquid flows in the upper chamber 1211 shrinks faster, and the response rate is improved, making the flow control effect of the oil inlet chamber 121 relatively good.

Further, since the inner diameter of the upper chamber 1211 is larger than the outer diameter of the second portion 1112, which prevents the second portion 1112 from being attached to the inner wall of the upper chamber 1211. The movement of the adjusting cylinder 111 in the axial direction can be blocked due to the viscous force of the oil.

Further, the axial length of the adjusting cylinder 111 is less than or equal to the that of the oil inlet chamber 121, and when the adjusting cylinder 111 moves in the axial direction, resulting in the collision between the adjusting cylinder 111 and the bottom of the lower chamber 1222, which reduces the wear of the adjusting cylinder 111 and the second protrusion 1228, and increases the service life of the pilot valve spool 11 and the pilot valve seat 12.

The axial length of the second portion 1112 is smaller than that of the upper chamber 1211, preventing the contact of the second portion 1112 on the top wall of the lower chamber 1222. The bottom portion of the second portion 1112 and the top wall portion of the lower chamber 1222 are avoided from blocking the movement of the adjusting cylinder 111 in the axial direction due to the viscous force of the oil, and the collision between the second portion 1112 and the upper end of the second protrusion 1228 is reduced, thereby reducing noise generation.

In another optional embodiment of the present application, as shown in FIGS. 1 to 4, the pilot valve spool 111 includes a supporting seat 112. The upper end face and lower end face of the support seat 112 are basically flat, and the adjusting cylinder 111 is connected to the lower end of the middle position of the supporting seat 112. Similarly, the pilot valve seat 12 also includes a supporting platform, the pilot chamber 2 is formed between the supporting platform and the supporting seat 112, and the pilot spring 13 is sleeved on the upper chamber 1211 of the oil inlet chamber 121.

In this embodiment, the upper surface of the supporting seat 112 corresponding to the pushrod 71 is set as a flat surface, so that when the pushrod 71 acts on the support seat 112 of the pilot valve spool 111, since the surface of the support seat 112 is flat, the pushrod 71 can smoothly contact the pilot valve spool 111. Compared to the contact between the valve ball and the top rod 71 in the prior art, the top rod 71 in this embodiment is less likely to slip and has a stable connection when acting on the pilot valve spool 111, thereby enabling the pilot valve spool 111 to move smoothly.

Further, as shown in FIGS. 1 to 4, the outer edge of the supporting seat 112 close to one end of the adjusting cylinder 111 is provided with an annular limit protrusion 113 for limiting the pilot spring 13 in the horizontal direction, which makes the pilot spring 13 can stably act between the pilot valve spool 111 and the pilot valve seat 12 without dislocation or offset, so as to ensure the stability of the action of the pilot spring 13.

In actual use, as shown in FIG. 8, the oil in the main valve chamber 4 enters the lower chamber 1222 through the radial oil inlet hole 1223, then enters the upper chamber 1211 through the lower chamber 1222, and then flows out from the radial oil outlet hole 1224 of the upper chamber 1211 into the pilot chamber 2.

When the pushrod 71 applies a downward pressure to the pilot core 111, the pilot core 111 moves downward against the pilot spring 13, and the adjusting cylinder 111 moves downward with the pilot core 111; as the first portion 1111 moves downward, the first portion 1111 enters the lower chamber 1222, the volume of the second part 1112 enters the upper chamber 1211 increases, the space in which oil can flow in the lower chamber 1222 decreases, and the flow rate of oil from the lower chamber 1222 to the upper chamber 1211 is reduced by the resistance of the first portion 1111, which reduces the flow rate of the lower chamber 1222 to the upper chamber 1211, and then decreases the hydraulic pressure in the pilot chamber 2.

The pushrod drives the pilot core 111 downward to the different positions, representing different pressures in the pilot chamber 2 and realizing the adjustment of the pressure in the pilot chamber 2.

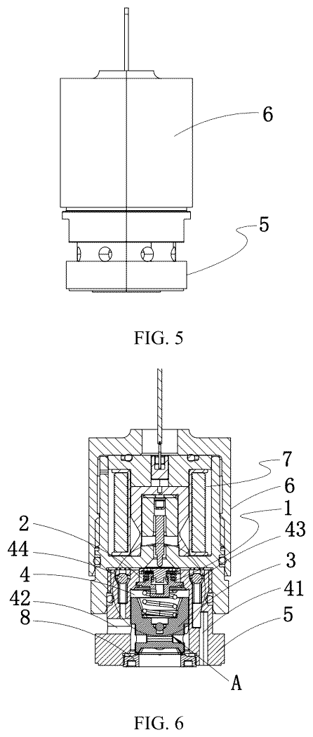

Secondly, the present application also provides a damping valve, which is applied to a vehicle vibration damping device, and the damping valve of the present application includes the pilot valve assembly 1 according to any one of the above embodiments; as shown in FIGS. 5 to 8, the damping valve further includes a main spool 3, a main valve seat 8, a valve sleeve 5, a housing 6, and an motor assembly 7; the valve sleeve 5 is provided with a pilot chamber 2 for installing the pilot valve assembly 1 and a main valve chamber 4 for installing the main spool 3, the main valve seat 8 is arranged at the lower end of the main spool 3, the pilot valve assembly 1 is close to the motor assembly 7, the main spool 3 is located on the other side of the pilot valve assembly 1 away from the motor assembly 7, the external oil flows into the main valve chamber 4 through the main spool 3, and the oil in the main valve chamber 4 through the pilot valve assembly 1 into the pilot chamber 2.

A fixed channel 21 and an adjustable channel 22 for discharging the oil in the pilot chamber 2 are formed between the pilot chamber 2, the valve sleeve 5 and the housing 6, and the oil in the pilot chamber 2 can be discharged through the fixed channel 21 and the adjustable channel 22, thereby speeding up the oil discharge rate in the pilot chamber 2 to assist the pressure control sensitivity in the pilot chamber 2.

The motor assembly 7 includes a pushrod 71, a coil, etc. In the present application, the motor assembly 7 is a prior art, and will not be repeatedly described here. The motor assembly 7 is used to provide power to drive the pilot valve spool 111 of the pilot valve assembly 1 to move up and down in the axial direction relative to the pilot valve seat 12 to change the size of the adjustable channel 22, that is, to change the flow volume and flow rate of the oil in the pilot chamber 2 from the adjustable channel 22 and the fixed channel 21 out of the damping valve, so as to change the pressure in the pilot chamber 2, and then control the opening degree of the main spool 3 through the pressure change of the pilot chamber 2. The adjustable channel 22 in this application is changed by the movement of the pilot valve spool 111, and the motor assembly 7 acts directly on the pilot valve spool 111, the connection between the motor assembly 7 and the pilot valve spool 111 is also more stable than the connection between the pushrod 71 and the valve ball, and the pilot valve spool 111 receives less uncertain factors, so the adjustable channel 22 can be kept stable, and then the pressure control of the pilot chamber 2 is stable, and the opening control effect of the main valve chamber 4 is fast, resulting in good damping control effect and fast response for shock absorbers or damping devices.

Further, as shown in FIGS. 1 to 4 and 7 to 8, the pilot valve spool 111 is provided with an oil outlet hole 114, the oil outlet hole 114 is provided on the supporting seat 112 of the pilot valve spool 111 along the axial direction. There is at least one oil outlet hole 114 connecting with the pilot chamber 2. Thus the oil in the pilot chamber 2 can flow into the adjustable channel 22 through the oil outlet hole 114.

Further, as shown in FIGS. 1 to 4 and 8, the outer edge of the top of the supporting seat 112 is provided with a sealing protrusion 115, and the sealing protrusion 115 protrudes upward in the axial direction. By providing the sealing protrusion 115, the adjustable channel 22 can be closed even if the pilot valve assembly 1 is not forced by the pushrod 71, and the sealing protrusion 115 is small in volume with less contact with the housing 6. The reduced contact area between the pilot valve spool 111 and the housing 6 can prevent the adhesion between the housing 6 and the pilot valve spool 111 due to hydraulic force and oil adhesion, ensuring the sensitivity of the up and down movement of the pilot valve spool 111, and thus ensuring the sensitivity of the pilot valve assembly 1 to the opening control between the main spool 3 and the main valve seat 8.

Further, as shown in FIGS. 3, 4, and 8, the outer edge of the bottom of the supporting seat 112 is provided with a limiting protrusion 113, and the limiting protrusion 113 protrudes downward in the axial direction for limiting the pilot spring 13 in the horizontal direction, which makes the pilot spring 13 stably act between the pilot valve spool 111 and the pilot valve seat 12 without dislocation or offset and ensure the stability of the action of the pilot spring 13.

Further, as shown in FIG. 6, the valve sleeve 5 is provided with a first oil flow path 41 and a second oil flow path 42, the first oil flow path 41 and the second oil flow path 42 are respectively provided on both sides of the pilot valve assembly 1, the first oil flow path 41 and the second oil flow path 42 are communicated with the outside of the damping valve, and the oil in the pilot chamber 2 flows into the first oil flow path 41 or the second oil flow path 42 through the adjustable channel 22 and the fixed channel 21, and then flows out of the damping valve through the first oil flow path 41 or the second oil flow path 42; the first check valve 43 is provided in the first oil flow path 41, and the second check valve 44 is provided in the second oil flow path 42. The advantages of this arrangement can ensure the unidirectionality of the first oil flow path 41 and the second oil flow path 42, and ensure that the first oil flow path 41 or the second oil flow path 42 can only lead the oil in the pilot chamber 2 to the outside, but cannot lead the external oil from the first oil flow path 41 or the second oil flow path 42 into the pilot chamber 2, thereby ensuring the stability of the oil flow out of the pilot chamber 2 and making the pressure regulation of the pilot chamber 2 stable.

In the actual use, when the motor assembly 7 does not act on the pilot valve assembly 1, the oil in the main valve chamber 4 flows into the oil inlet chamber 121 through the radial oil inlet hole 1223, and then flows out from the oil inlet chamber 121 to the pilot chamber 2 from the radial oil outlet hole 1224, at this time, the adjustable channel 22 is closed, and the oil can only flow out of the pilot chamber 2 to the first oil flow path 41 or the second oil flow path 42 through the fixed channel 21 and flow out of the damping valve; at this time, the force of hydraulic oil in the pilot chamber 2 is large, the opening of the main spool 3 is small, and the damping of the shock absorber is large.

When the motor assembly 7 acts on the pilot valve assembly 1 and applies a downward force in the axial direction to the pilot valve spool 111, the pilot valve spool 111 overcomes the pilot spring 13 to move downward, the adjusting cylinder 111 also moves downward with the pilot valve spool 111, the top of the pilot valve spool 111 is gradually separated from the housing 6, the adjustable channel 22 becomes larger, and the oil can flow out from the variable channel to the second oil flow path 42 or the first oil flow path 41 from the pilot chamber 2 through the oil outlet hole 114; after the first portion 1111 moves downward into the lower chamber 1222, the volume of the second portion 1112 entering the upper chamber 1211 increases, the resistance received by the oil in the lower chamber 1222 when injecting oil from the radial oil inlet hole 1223 increases with decreasing flow volume and flow rate, the flow volume and flow rate of the oil flowing out of the oil inlet chamber 121 to the pilot chamber 2 decrease, the amount of hydraulic oil available for the pilot chamber 2 decreases, the pressure of hydraulic oil received at the bottom of the main spool 3 increases, the main spool 3 gradually moves up, the opening degree of the main spool 3 increases, and the damping of the shock absorber decreases.

The motor assembly 7 drives the pilot core 111 downward to the different positions in the axial direction that represents different pressures in the pilot chamber 2, realizing the adjustment of the pressure in the pilot chamber 2.

What is claimed is:

1. A pilot valve seat is applicable to a damping valve in a shock absorber. The abovementioned damping valve comprises a pilot valve assembly, a valve sleeve and a housing. The housing is connected to the valve sleeve and the pilot valve assembly is disposed in the valve sleeve; the pilot valve assembly includes a pilot valve spool, a pilot seat and a pilot spring; wherein,
the pilot spring is installed between the pilot valve spool and the pilot valve seat;
a pilot chamber formed by the pilot valve spool, the pilot valve seat, the damping valve housing and valve sleeve;
wherein, an oil inlet chamber is provided on the pilot valve seat, and the oil inlet chamber is connected to the pilot chamber;
the oil inlet chamber comprises a radial oil inlet and an oil outlet;
the pilot valve spool is provided with an adjusting cylinder matched with the oil inlet chamber, and the adjusting cylinder can move axially with the pilot valve spool to control the flow rate of the oil inlet chamber.

2. The pilot valve seat according to claim 1, wherein
the oil inlet chamber of the pilot valve seat is provided with a mating hole that mates with the adjusting cylinder, and the adjusting cylinder enters the oil inlet chamber through the mating hole to adjust the flow rate of the oil inlet chamber.

3. The pilot valve seat according to claim 1, wherein
the oil inlet chamber includes an upper chamber and a lower chamber connecting with each other;
the upper chamber is partially into the pilot chamber, and the radial oil outlet hole is provided on the upper chamber;
the lower chamber is partially into the main valve chamber of the main valve, and the radial oil inlet hole is provided on the lower chamber.

4. The pilot valve seat according to claim 3, wherein
the lower chamber includes an axial connecting port for connecting to the upper chamber;
the adjusting cylinder includes a first portion and a second portion, the first portion connects the lower chamber to the upper chamber.

5. The pilot valve seat according to claim 4, wherein
the adjusting cylinder includes the second portion matching with the axial mounting hole;
the outer diameter of the second portion is larger than the diameter of the axial connecting port.

6. The pilot valve seat according to claim 5, wherein:
the inner diameter of the upper chamber of the pilot valve seat is larger than the outer diameter of the second portion.

7. The pilot valve seat according to claim 5, wherein
the axial length of the adjusting cylinder is smaller than the axial length of the oil inlet chamber;
the axial length of the second portion is less than the axial length of the upper chamber.

8. The pilot valve seat according to claim 1, wherein
the pilot valve spool includes a support seat, and the adjusting cylinder is connected at the lower end of the support seat;
one end of the support seat close to the adjusting cylinder is provided with a limiting protrusion.

9. A damping valve applicable to a vehicle damping device, comprises the pilot valve seat according to claim 1;
the damping valve comprises a main spool, a main valve seat and a motor assembly. The main spool and the main valve seat are arranged in the valve sleeve, and the main valve seat is arranged at the bottom of the main spool;
the pilot chamber for installing a pilot valve is arranged in the valve sleeve;
a fixed channel and an adjustable channel for discharging oil in the pilot chamber are formed between the pilot chamber, the valve sleeve and the housing;
the motor assembly can drive the pilot valve spool to move axially relative to the pilot valve seat to change the open area of the adjustable channel.

10. The damping valve according to claim 9, wherein
the pilot valve spool is provided with an oil outlet hole, and the oil in the pilot chamber can flow into the adjustable channel through the oil outlet hole.
